(19) United States
(12) Patent Application Publication
(10) Pub. No.: US 2008/0300995 A1
(43) Pub. Date: Dec. 4, 2008

(54) DYNAMIC METHODS OF AWARDING A SUPPLIER BASED UPON CUSTOMERS CRITERIA

(76) Inventor: Vladislava Smejkalova, Paris (FR)

Correspondence Address: MEREDITH & KEYHANI, PLLC, 330 MADISON AVE., 6TH FLOOR, NEW YORK, NY, 10017, US

(21) Appl. No.: 11/754,593

(22) Filed: May 29, 2007

(51) Int. Cl. G06Q 30/00

(52) U.S. Cl. 705/26

(57) ABSTRACT

A method of awarding a supplier's offer based upon a customer's competition criteria, comprising the steps of: accepting an input of requirements from a customer; accepting a criteria of rating supplier offers according to criteria importance to provide a weight index; searching for convenient suppliers based on requirements from the customer; informing the convenient suppliers of a request from the customer; accepting an offer from at least one supplier, wherein the at least one offer has supplier input information; providing a weighted score by multiplying each supplier input information of rating by weight index to provide a weighted score according to the customers competition criteria; accepting a selection by the customer of at least one offer from at least one supplier according to the customers competition criteria; informing each supplier of the selection by the customer.

The present invention relates generally to methods for selecting a vendor or provider for their job or task.

Goods or services are commonly sold over the internet. However, one of the problems is that currently goods or services are generally purchased by performing a search engine search and then sifting through websites and emails to determine the best vendor. The wide variation of goods and services available online increases the amount of time required to find a vendor and requires the consumer to spend a great deal of time looking for a fulfillment provider that meets their needs.

Currently, there are websites offering referrals. This can be daunting for the user as they do not know if the supplier has paid for the referral or if the quality of the goods or services is up to their standards. Because of this, websites such as ebay and others providing ratings systems where a user can evaluate the sellers and buyers performance and provide a score. However, the scoring system is flawed because it is prone to the criteria of the individual buyers and sellers doing the rating.

Accordingly, what is needed is a dynamic rating system and methods of awarding jobs and tasks that provides for evaluations and rating scores according to the specific criteria of the buyer and seller and subsequent buyers and sellers.

### SUMMARY OF THE INVENTION

The present invention relates generally to methods for awarding a task or job.

According to one embodiment, a method of awarding a supplier's offer based upon a customer's competition criteria is provided, the method comprising the steps of: accepting an input of requirements from a customer; accepting a criteria of rating supplier offers according to criteria importance to provide a weight index, wherein the weight index is a value between 0 to 1 wherein the number of weight indexes adds up to one; searching for convenient suppliers based on the requirements from the customer; informing the convenient suppliers of a request from the customer; accepting an offer from at least one supplier, wherein the at least one offer has supplier input information of rating; providing a weighted score by multiplying each supplier input information of rating by the weight index to provide a weighted score according to the customers competition criteria; accepting customer's dynamic changes of any competition criteria, its weight and requirements and supplier's dynamic changes at any time within the competition period; providing a customer a system where he can determine, using the offer's rating system based on his own requirements as a support, final order of offers that may be made public or kept private; accepting a selection by the customer of at least one offer from at least one supplier according to the customers competition criteria; and informing each supplier of the selection by the customer. All tools applied will be there for a customer as well as supplier to make the most accurate and objective decision concerning their potential mutual cooperation.

According to another embodiment, a method of awarding a supplier's offer based upon customer's competition criteria is provided, the method comprising the steps of: accepting an input of requirements from a first evaluating customer; providing an adjusted weighted evaluation from a second and others evaluating customers to a first supplier's evaluating customer (or using already existing evaluation of supplier's previous performance as evaluation criteria); accepting a criteria of rating supplier offers from the first evaluating customer according to the criteria importance to provide an importance index indicating the proximity of supplier's input to the first customer's competition criteria; searching for suppliers based on the competition criteria from the first customer to provide a list of convenient suppliers; informing the convenient suppliers of a request from the first evaluating customer; accepting an offer from at least one convenient supplier; providing an evaluation to the first (or any) customer according to the supplier input information, the weighted evaluation from the second evaluating customer and the importance index to provide a score according to the customers competition criteria (weighted evaluation of supplier's performance may be used as offer's rating and evaluation criteria by any customer for already evaluated suppliers); accepting a selection by the customer of one offer from at least one convenient supplier to provide a selected supplier; and informing each selected supplier of the selection by the customer, wherein the at least one offer has supplier input information of rating.

According to another embodiment, a method of awarding a supplier's offer based upon customer's competition criteria, said method comprising the steps of: accepting an input of requirements from a customer; accepting a criteria of rating supplier offers to provide an importance input; searching for convenient suppliers based on the requirements from the customer; informing the convenient suppliers of a request from the customer; accepting an offer from at least one supplier, wherein the at least one offer has supplier input information; providing a score to the customer according to the importance input and the supplier input information to provide a rating; providing a system allowing dynamic changes of competition criteria, their weight and competition requirements by customers, dynamic changes of any offered entry by suppliers where offer's score and rating shall be reflecting any alternations; accepting a selection by a customer of at least one offer from at least one supplier according to customer's competition criteria and rating; and informing each supplier of the selection by the customer and eventually customer's final order of offers .

These and other features, aspects and advantages of the present invention will become better understood with reference to the following description and claims.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

One object of the invention is, to allow customers to provide information on the criteria that is most important to them and utilize other customers evaluations and system evaluations to determine the best suited provided or supplier for their needs and preferences; and also to provide a system of evaluation of customers to supply the suppliers with information about customers for the best selection of a request and most optimum response to the request. A method of awarding a supplier's offer based upon a customer's competition criteria, the method comprising the steps of: accepting requirements from a customer; accepting a criteria of rating supplier offers according to criteria importance to provide a weight index, wherein the weight index is a value between 0 to 1 wherein the number of the weight indexes adds up to one; searching for convenient suppliers based on the requirements from the customer; informing the convenient suppliers of a request from the customer; accepting any change in required competition criteria, its weight or any change in offered aspect during competition period; accepting an offer from at least one supplier, wherein the at least one offer has supplier input criteria of rating; providing a weighted score by multiplying each supplier input information of rating by the weight index to provide a weighted score according to the customers competition criteria; accepting a selection and ranking by the customer of at least one offer from at least one supplier according to the customers competition criteria; there may be also the step of providing a flexible system of a score and a rank change after any competition aspect change by a customer or a supplier; and informing each supplier of the selection by the customer and eventually about customer's final judgment on decisive order of offers. The system may allow a customer to determine his own order of offers in addition to the ranked list of offers, wherein the final order of supplier's offers may public or private according to the customer. The “job or task” may be based on the customer's input of requirements. It is a customer, who sets the competition rules/frame by deciding importance of criteria for his request and designates the criteria importance and it's a customer who can change them at any time during the competition period. The input of requirements may be selected from the group consisting of project description, turnaround, category type, business type, budget, planning, location, skills required, experience required, task duration, task frequency, other requirements, experience, lowest price, highest price, system evaluations, desired method of evaluation and previous supplier's performance evaluations. The input of requirements, criteria of rating, requests, offers, etc. are stored on a system computer or database. Suppliers will make their offers to customers' request online and can change any aspect of their offer during the competition time. There may also be the step of accepting a criteria of evaluation of supplier's performance, wherein the criteria of evaluation of supplier's performance may be selected from the group consisting of budget respect, planning respect, professional approach, personal approach, reliability, flexibility, overall impression, length, location, rating rules, comments, evaluation method, efficiency on the system, number of won competitions, number of withdrawn competitions. According to the choice, an offer from at least one supplier may be evaluated by the system to provide a weighted score. The order of the suppliers will be shown during the whole competition period on the site and will be given by suppliers offer's weighted score. The system will evaluate offers by matching them with customers' requests as well as comparing them with other competitors' offers. Any input of requirements, or request, of a customer or any part of supplier's offer can be modified during the competition period. The term evaluation may include weighted and non weighted evaluations. Customer evolution is intended to refer to changes in the customer's input of requirements, suppliers' offers, including change in customer's requirements, change in supplier input information and any other relevant change.

There may be three basic types of competitions, (1) all criteria; (2) first reply wins; and (3) cheapest offer wins. The “1^{st} reply wins” and the “The cheapest offer wins” selection procedures are one criteria competitions and are simplified versions of the “All criteria” selection procedure. The first step may be that the customer defines his requirements on a task to be done and criteria of rating (evaluation) of supplier's offers and other data like beginning and end of the competition. A customer defines competition rules/frame. There may be a YES & NO form to ask specific questions to a potential supplier. The system may search for most convenient suppliers based on the category (and other criteria) provided by the customer and will inform suppliers about the task/job request. Competition: suppliers compete for the request (task) of the customer during the competition period by adapting their offers to customer's request and their competitors reaction. The system will take into account the criteria of the customer and compares them with the offers of suppliers and also will compare to other competitors offers. Suppliers can at any time change any offers criteria and customers can change any request or competition rule in the competition period. The system shall inform the customers as well as suppliers about the competition situation and about all important events and competition changes. The system will constantly and at all times rate offers of suppliers. The rating system will be launched automatically at events like: (1) new or change in an offer of a competitor; (2) customers' creation or change of requests. The site can also organize online & non line meetings for customers with their suppliers and other business tools for information exchange and optimization. (The customer can select any of the tools as a support for his decision.) The customer chooses his supplier and can even determine the final order of supplier's offers and a supplier confirms his acceptance. If the winning supplier doesn't confirm its acceptance than the order of offers determined by the customer or rated order of the system if customer accepted it, becomes important. Then a customer and a supplier will be mutually informed about their contact details. The customer(s) and supplier(s) shall after certain period since the competition end evaluate each other's performance.

Every offer may be rated by two (2) basic and one (1) global method of rating. Rating one (1) and two (2) are independent; rating three (3) is a final score and may include the first two ratings. The first two ratings are calculated in a very similar way. All ratings can be expressed in percentage as well as graphically. Also, it should be understood that rating may be the rating of offer's score, and the offer's score is a result of comparing the customer's competition criteria with supplier's offer. The first rating (1) may be an offer to offer rating. Criteria given by a customer in his offer will be compared with supplier's proposed values in his offer. This rating takes into account the importance (weight) of customer's criteria. The final score is computed as a weighted score of a group of partial scores (in various criteria). The weights correspond to each criteria importance for a customer. Some criteria may have several sub-criteria that are calculated similarly as the overall score, for example experiences can be demanded in various fields, so each experience is rated for each domain separately and the overall experience rate is calculated as a weighted score of individual once.

There may be different predefined desired methods of evaluation such as a multicriteria weighted method, a multicriteria “proximity” or other method; and/or a single criteria method (only one criteria counts like “budget” for example, meaning that the customer is only interested in the cheapest offer.)

Offer to offer ratings may have three levels of computations. Only the final result of all computations (result of level 3) will typically be visualized to users. Level 1: This level of detailed computation is a preparatory support for the level 2 and is necessary to obtain numeric representation of the input (offer's data) of each criterion, for ex. Customer can request variously important experiences in many domains. The result may be a detailed rate per criteria with, in some cases, taking into account a weight index determined by a customer. Result will be a numeric representation of offer's data for every criterion. Level 2: Partial computation will compare each numeric representation of a criteria (output of level 1) of one offer to the best offered criterion. The result will be a rate per each criterion with respect to the best offers. The result value will be between 0-1. Level 3: Final offer to offer computation will take into account final rates of all criteria (calculated at the level 2) and will also take into account the weight index for each of the criterion. The final result will be a final rate of every offer (with respect to other offers). The result value will be shown to all users in % as well as in a graphical symbol. It should be understood that all formulas are for demonstration purposes only and are not to be taken in a limiting sense.

LEVEL 3: Final Offer to Offer Rating

General formula:

Final Offer2Offer rate=(Σ(Partial rating for each criteria*weight index))/Σ(weight indexes)

otherwise said:

Final Offer2Offer rate=(prA*wi A+prB*wi B+ . . . +pr Z*wi Z)/(wi A+wi B+ . . . +wi Z);

where pr means Partial Rate; wi=weight index given by customer per criteria.

The final rate in %=Final Offer2Offer rate*100 (%)

### LEVEL 2: Partial Rating for Each Criterion

The best criteria can have either the biggest value (ex. Experience) or the smallest value (ex. Budget). To obtain the value between 0 and 1, the best criteria will be placed in the numerator or in the denominator accordingly.

Vocabulary: The “best offer” is the best offer per criterion (ex. Best price), the “rated offer” is the offer that is compared with the best offer.

General formula for the best criteria (or best value offered)=smallest value Partial rating=Best offer/Rated offer=X (a number between 0-1) (Exception: Best offer should be bigger than 0. Partial rating=(Best offer+1)/( Rated offer+1)=X. Adding number 1 to each criteria is useful for not obtaining a 0 in the divider.) A/

General formula for the best criteria (or best value offered)=biggest value Partial rating=Rated offer/Best offer=X (a number between 0-1) B/

Exception: The only exception to the partial rating computation will be in the YES/NO reply evaluation, where each reply can have a value 0 (%) or 1 (100%). The index of weight will be also taken into account in this case.

The second rating method may be a comply/not comply rating. This rating will evaluate if a competitor's offer corresponds or not to customer's requested criteria and to which extent (meaning how far are “not comply offers” to customers requirements). (The compatibility (comply) score is based, into certain extent, on the similar principle and formulas as the selection score (offer to offer rating).)

### Calculation

Level 1: We have to decide which referential value is to be taken into further calculation.

### Decision Making:

1. Compare the offered value with the required value
2. Determine the referential value for 2^{nd} level computation
A/In a case where a higher offered value is better for a customer (for ex. years of experience), than the referential value is the smaller value out of out of two compared values: the requested and offered one.

Formula: referential value=min (requested value, offered value)
B/In a case where a lower offered value is better for a customer (for ex. budget), than the referential value is the biggest value out of two compared values: the requested and the offered one.

Formula: referential value=max (requested value, offered value)

### Level 2

Here we compare the offered and required values. We take into account the referential value (from previous computation) and calculate the Comply Rate.
A) if the highest offered value is better for a customer then:
   Comply rating=referential value/requested value
B) if the lowest offered value is better for a customer then:
   Comply Rating=requested value/referential value

### Level 3

This is a final computation. It uses the same logic as applied for the offer2offer rating. We compute weighted average of rating results from level 2.

The third rating method may be a global rating. Global rating may take into account the two previous ratings for example in the following way;

Global rating=(Best offer percentage of an offer+Comply/Not comply of an offer)/2

If a customer wishes he can customize which out of two ratings (“Offer to Offer” or “Comply/Not Comply”) is more important and by giving more weight to one or the other, (in that case not a simple average but a weighted score will be calculated for the global evaluation).

I. Evaluation of Users' Performance
There are following types of users' evaluations:
1. User to User evaluation (for ex. customer's evaluation given by a supplier)
2. Geenus Evaluation (evaluation by Geenus of users' performance)
3. Global evaluation composes of User's evaluation (1) and the Geenus evaluation (2)

There may also be customer to supplier and supplier to customer evaluation. There will be no fundamental difference between the customer's and supplier's evaluation in terms of technique, only the assignment to a user. The evaluation criteria will be given by professional and also by other criteria describing personal qualities of a supplier or a customer like: reliability and personal approach.

### Users' Evaluation can be Weighted or Un-Weighted Sum of All Criteria:

The present invention may provide a users' evaluation on the system, which will be calculated as unweighted sum of following criteria:

Efficiency on system (12) for a supplier=(a+b)/2
a) Successfully completed competitions (%)=(number of completed competitions (without withdrawing)/number of participated competitions) *100
b) Success in responding to a customer (%)−will be determined according to supplier's reaction, for example average reply time until 24 hours (100%), average reply time until 48 hours (for ex. 80%) etc.

Efficiency on System (12) for a customer=(a+b)/2
a) Successfully launched Competitions (%)=Completed Competitions (not withdrawn competitions, it does not mean that a customer had to find a supplier)/Launched competitions*100
b) Success in responding to a supplier (%)−will be determined similarly as stated for a supplier.

There are other statistics that will be displayed on the system (12) pages. There may be, for example a global evaluation composed of User's evaluation (1) and the system evaluation (2) its value will be set as an average value, but any user can visualize this global evaluation differently by giving more importance (weight) to either user2user evaluation or to the system evaluation. This purpose of the invention is, to allow, users to provide information on the criteria that is most important to them and utilize other users evaluations and system evaluations to determine the best suited provided or supplier for their needs and preferences.

All ratings, performance evaluations may be in the background expressed in percentages and then may be transformed into a graphical representation. The form will express a number of evaluations for this user.

The step of accepting an input of requirements from a customer may further comprise the step of assigning a public or private status to at least one input. For example, a weighted evaluation may be made public allowing other customer's to see the evaluation. The public evaluation may also be tailored according to the users criteria, or both weighted evaluations may be provided. The method may further comprise the step of: accepting a weighted evaluation from each customer, wherein each weighted evaluation changes according to each customer's weight indexes and rates at least one supplier's performance.

The requirements may be selected from the group consisting of project description, turnaround, experience, lowest price, highest price, system evaluations, and previous evaluations. The criteria of customer's and supplier's performance evaluation may be selected from the group consisting of budget respect, planning respect, professional approach, personal approach, reliability, flexibility, overall impression, length, location, rating rules, comments and evaluation method.

The method may further comprise the steps of the supplier either accepting or withdrawing the offer according to supplier selection criteria. The supplier selection criteria may be selected from the group consisting of category type, business type, budget, location, skills required, experience required, task duration, task frequency, other requirements and customer's performance criteria like: budget respect, planning respect, professional approach, personal approach, reliability, flexibility, overall impression, prior other supplier evaluation, efficiency on the system including number of won competitions, number of withdrawn competitions and comments.

It may be desirable for the system to automatically generate a system evaluation of the supplier's performance and the customer's performance after the competition. The step of weighting each offer may be comprised of the step of multiplying each criteria of rating by the weight index to provide a weighted rating and summing each weighted rating to provide a summed weighted rating, dividing the summed weighted rating by the sum of the weighted indexes to provide a final offer to offer rating. There may also be a changed criteria of rating and a correlated weight index and other criteria from a customer to provide a changed weight index during the selection time. This may be accepted as well as a changed supplier input information for rating and other criteria any moment during the selection time and competition time. A new weighted score will then be provided by multiplying each supplier input information by the weight index to provide a weighted score according to the customers competition criteria wherein there is any change in the weighted score.

A weighted score may be provided for any offer according to another customer's evaluation, wherein customer's evaluation is parsed according to supplier input information. If a supplier has no previous evaluation, a dummy performance evaluation may be used or none at all. The terms first and second customer may be any customer but is intended to depict that they are in fact two different customers. The term parsed, refers to the facts that different criteria are separated out and assigned to another supplier offer (by the same supplier) according to another customers preferences. The method may further comprise the step of: dynamic ranking the offer's according to the criteria importance to provide a ranked list of offers reflecting any change from a customer or supplier/s; providing the ranked list of offers to the customer. The method may further comprise the steps of: assigning average or other values to the supplier input information for at least not yet-evaluated supplier to provide a dummy weighted score.

A method of awarding a supplier's offer based upon customer's competition criteria, the method comprising the steps of: accepting an input of requirements from a customer; providing an adjusted weighted evaluation of a supplier's performance after the competition end from a second and other evaluating customer (and their prior evaluation) to the first customer (in this embodiment there is no interaction of customer to customer evaluation, but customer to supplier evaluation); accepting a criteria of rating supplier offers from a customer according to the criteria importance to provide an importance index indicating the proximity of supplier's input to the customer's competition criteria; searching for suppliers based on the competition criteria from any customer to provide a list of convenient suppliers; informing the convenient suppliers of a request from the first customer and any other customer; accepting an offer from at least one convenient supplier; providing an evaluation to the customer according to the supplier input information, the weighted evaluation from the second evaluating customer and importance index to provide a score according to customers competition criteria; accepting a selection by the customer of one offer from at least one said convenient supplier to provide a selected supplier; and informing each selected supplier of the selection by the customer, wherein the at least one offer the supplier input information. The method may further comprise the steps of: searching for convenient suppliers based on the input of requirements from the customer; informing the convenient suppliers of a request from the customer; accepting an offer from at least one supplier, wherein the at least one offer has supplier input information; providing a weighted score by multiplying each supplier input information by the importance index to provide a weighted score according to the customers competition criteria; accepting a selection by the customer of at least one offer from at least one supplier according to the customers competition criteria; and informing each supplier of the selection by the customer.

The method may further comprise the step of: accepting a weighted evaluation of a supplier or of competition criteria from the customer, wherein the weighted evaluation of a supplier changes according to each customers rating criteria, their weight and rates each of the suppliers offers. The weighted evaluation (representing expectations and important factors of customer's request) may be made public. The customer's requirements may be selected from the group consisting of project description, location, turnaround, experience, lowest price, highest price, system evaluations and previous evaluations. The criteria of previous supplier's performance evaluation may be selected from the group consisting of budget respect, planning respect, professional approach, personal approach, reliability, flexibility, overall impression, length, location, budget, planning, rating rules, comments and evaluation method. The supplier selection criteria may be selected from the group consisting of category type, business type, budget, location, skills required, experience required, task duration, task frequency, other requirements and customer's performance criteria such as budget, respect, planning respect, professional approach, personal approach, reliability, flexibility, overall impression and comments, prior other supplier's evaluations of a customer performance and efficiency on the system including number of won competitions, number of withdrawn competitions prior to customer's performance on the system. The method may further comprising the steps of the supplier either accepting or withdrawing the offer according to supplier selection criteria; and the customer either completing or withdrawing from the competition owing to suppliers' offers change and other inducement. Also, the method may comprise the step of accepting mutual evaluation of customer's and supplier's performance of the task some time after the competition end. This evaluation may become part of the competition rating.

The steps of providing a system based supplier evaluation may be according to the number of successfully completed competitions and success in responding to a customer. The method may further comprise the steps of accepting a changed competition rating and a correlated importance index and other criteria from a customer to provide a changed weight index during the selection time; accepting a changed supplier input information for rating and other criteria any moment during the selection time; providing a new weighted score by multiplying each supplier input information by the weight index to provide a weighted score according to the customers competition criteria wherein there is any change in the weighted score. The method may further comprise the steps of the supplier either accepting or withdrawing the offer according to a supplier selection criteria. A ranked list of offers may be provided to the customer according to the criteria importance to provide a ranked list of offers. In this way, the prior customer's evaluation of supplier's performance may provide useful information according to the preferences of another customer. In this way, already existing supplier's evaluations of his performance by his previous customers may be used as offer evaluation criteria by any other customers. This may present unfair advantage or disadvantage to suppliers with who have not previously provided services or goods. Because of this, it may be desirable to provide a dummy weighted evaluation utilized as if it was a second evaluating customer weighted evaluation or to display such supplier's offers apart from already evaluated suppliers.

According to another embodiment, a method of awarding a supplier's offer based upon customer's competition criteria is provided, the method comprising the steps of: accepting an input of requirements from a customer; accepting a criteria of rating supplier offers to provide an importance input; searching for convenient suppliers based on the requirements from the customer; informing the convenient suppliers of a request from the customer; accepting an offer from at least one supplier, wherein the at least one offer has supplier input information; providing a score to the customer according to the importance input and the supplier input information to provide a rating; accepting a selection by the customer of at least one offer from at least one supplier according to the customers competition criteria and the rating; providing a customer a possibility to decide on the final order of suppliers' offers having a possibility to publish or not this order and informing each supplier of the selection of the winning supplier by the customer. At least one input of requirement may be assigned as public or private.

The method may comprise the step of accepting a weighted and non-weighted evaluation of supplier's and customer's performance from a customer or a supplier some time after the competition end, wherein the weighted evaluation is parsed and changes according to each subsequent importance input, wherein for non weighted evaluation all evaluation criteria have the same importance. For weighted evaluation example, if a first evaluating customer thought that timeliness in responding was the most important criteria and quality was an unimportant criteria, a prior evaluation which said the same supplier was quick to respond but the quality was not very good would rate higher than another supplier who was slow to respond but the quality was much higher within the competition. This is one of the dynamic aspects, among others, of the present invention, in that allows prior evaluations by suppliers and customers to be finally influenced according to the importance and preference of newly evaluating suppliers and customers. There may be any number of criteria that are important and they may be specifically tailored or according to preset inputs. Evaluations given by customers to suppliers some time after competition end can be proposed to all new customers as models during filling in new competition requirements criteria; this can be useful because certain criteria may have more importance/weigh in some businesses than others, for example time/planning respect may be more important for logistics company's than personal approach. There may also be an automatically generated system evaluation of the supplier and the customer. For example, the amount of time it takes a supplier or a customer to respond to questions may be automatically recorded and provide an input. When a customer or a supplier indicates that they value the time to respond, that system generated input may become another variable in the input of requirements. There may also be comments.

The method may comprise the steps of the supplier either accepting or withdrawing the offer according to supplier selection criteria. The supplier selection criteria may be selected from the group consisting of category type, business type, budget, location, skills required, experience required, task duration, task frequency, other requirements and customer's performance criteria like: budget, respect, planning respect, professional approach, personal approach, reliability, flexibility, overall impression, prior other supplier evaluation, and customer's efficiency on the system including number of withdrawn competitions and comments.

The method may comprise the steps of the customer withdrawing the request according to suppliers offers quality, quantity and other aspects. The method may also comprise the steps of the customer either completing or withdrawing from the competition owing to suppliers' offers change and other inducement.

As always, any time, criteria of rating, competition criteria, competition rules, supplier input information and any other inputs may be changed at any time and the system update the weighted score. This may be according to the following: accepting a changed criteria of rating and a correlated weight index and other criteria from a customer to provide a changed weight index during the selection time; accepting a changed supplier input information for rating and other criteria any moment during the competition time (not “selection time”, which time after competition is closed and a customer chooses his supplier, supplier, so suppliers cannot change their offers any more. During “selection time” a customer may use other evaluation and simulation tools to view offers of his potential suppliers form different angels in order to determine his final decisive order of suppliers' offers. None of his simulations will be made public unless a customer does not explicitly wishes to do so, he is only requested to announce the winning supplier's offer; providing a new weighted score by multiplying each supplier input information by the weight index to provide a weighted score according to the customers competition criteria wherein there is any change in the weighted score.

If a customer chooses supplier's performance amongst determining criteria for his request, a weighted score of supplier's performance may be provided on the basis of existing previous evaluations of the supplier, wherein the offer's ranking is parsed according to customer input information. The not yet existing evaluation of supplier's performance may be substituted by a dummy weighted evaluation; offers of such suppliers or such offers (of not yet evaluated suppliers) may be displayed apart in a separate group of offers. In this way, suppliers without a history in the system would not be prejudiced but would be in a “new supplier” (for example) group. The offers may be ranked according to the criteria importance to provide a ranked list of offers; and providing the ranked list of offers to the customer.

It should be understood that the foregoing relates to preferred embodiments of the invention and that modifications may be made without departing from the spirit and scope of the invention as set forth in the following claims.

I claim:

1. A computer implement method of awarding a supplier's offer based upon a customer's competition criteria, said method comprising the steps of:
accepting an input of requirements from a customer;
accepting a criteria of rating supplier offers according to criteria importance to provide a weight index, wherein said weight index is a value between 0 to 1 wherein the number of said weight indexes adds up to one;
searching for convenient suppliers based on said requirements from said customer;
informing said convenient suppliers of a request from said customer;
accepting an offer from at least one supplier, wherein said at least one offer has supplier input information;
providing a weighted score by multiplying each said supplier input information by said weight index to provide a weighted score according to said customers competition criteria;
accepting a selection and ranking by said customer of at least one offer from at least one supplier according to said customers competition criteria; and
informing each said supplier of said selection by said customer.

2. A method as in claim 1, wherein said step of accepting an input of requirements from a customer further comprises the step of:
assigning a public or private status to at least one input of requirements.

3. A method as in claim 1, further comprising the step of accepting mutual evaluation of customer's and supplier's performance of the task some time after the competition end.

4. A method of awarding a supplier's offer based upon customer's competition criteria as in claim 1, further comprising the step of:
accepting a weighted evaluation of supplier's performance from said customer after the end of the competition, wherein said weighted evaluation changes according to each said customers weight indexes and rates said at least one suppliers performance.

5. A method of awarding a supplier's offer based upon customer's competition criteria as in claim 4, further comprising the step of:
making said weighted evaluation public.

6. A method of awarding a supplier's offer based upon customer's competition criteria as in claim 1, wherein said input of requirements may be selected from the group consisting of project description, turnaround, category type, business type, budget, planning, location, skills required, experience required, task duration, task frequency, other requirements, experience, lowest price, highest price, system evaluations, desired method of evaluation and previous supplier's performance evaluations.

7. A method of awarding a supplier's offer based upon customer's competition as in claim 1, further comprising the steps of accepting a criteria of evaluation of supplier's performance, wherein said criteria of evaluation of supplier's performance may be selected from the group consisting of budget respect, planning respect, professional approach, personal approach, reliability, flexibility, overall impression, length, location, rating rules, comments, evaluation method, efficiency on the system, number of won competitions, number of withdrawn competitions.

8. A method of awarding a supplier's offer based upon customer's competition as in claim 7, wherein said supplier selection criteria is selected from the group consisting of category (business type), budget, location, skills required, experience required, task duration, task frequency, other requirements and customer's performance criteria like: budget respect, planning respect, professional approach, personal approach, reliability, flexibility, overall impression, prior other supplier evaluation, customer's efficiency on the system including number of successfully completed competitions, success in responding to a supplier and comments.

9. A method of awarding a supplier's offer based upon customer's competition criteria as in claim 1, further comprising the steps of providing an automatically generated system evaluation of said supplier.

10. A method of awarding a supplier's offer based upon customer's competition criteria as in claim 1, wherein said step of weighting said at least one offer is further comprising the steps of:
multiplying each said criteria of rating by said weight index to provide a weighted rating and summing each said weighted rating to provide a summed weighted rating, dividing said summed weighted rating by the sum of said weighted indexes to provide a final offer to offer rating.

11. A method of awarding a supplier's offer based upon customer's competition criteria as in claim 1, further comprising the step of:
accepting a changed criteria of rating and a correlated weight index and other criteria from a customer to provide a changed weight index during the competition time and the selection time;
accepting a changed supplier input information for rating and other criteria any moment during said competition time;
providing a new weighted score by multiplying each said supplier input information by said weight index to provide a weighted score according to said customers competition criteria wherein there is any change in said weighted score.

12. A method of awarding a supplier's offer based upon customer's competition criteria as in claim 1, further comprising the step of:
providing a weighted score according to existing customer's evaluation of supplier's performance, wherein said existing customer's evaluation of supplier's performance is parsed according to supplier input criteria.

13. A method of awarding a supplier's offer based upon customer's competition criteria as in claim 1, further comprising the step of:
ranking said offer's according to said criteria importance to provide a ranked list of offers, wherein said ranked list of offers can dynamically change after a change in said customer's requirements or said offer;
providing said ranked list of offers to said customer;
providing a system allowing a customer to determine his own order of offers in addition to said ranked list of offers, wherein the final order of supplier's offers may public or private according to customer.

14. A method of awarding a supplier's offer based upon customer's competition criteria as in claim 1, further comprising the step of:
Assigning average or other values to said supplier input information for at least one supplier to provide a dummy weighted score.

15. A method of awarding supplier's offer based upon customer's competition criteria as in claim 1, further comprising the step of:
accepting evaluation of customer's performance by supplier.

16. A computer implemented method of awarding a supplier's offer based upon customer's competition criteria, said method comprising the steps of:
accepting an input of requirements from at least one customer;
providing an adjusted weighted evaluation from prior evaluations to said at least one customer;
accepting a criteria of rating supplier offers from said prior evaluations according to the criteria importance to provide an importance index indicating the proximity of supplier's input to said customer's competition criteria;
searching for suppliers based on said competition criteria from said customer to provide a list of convenient suppliers;
informing said convenient suppliers of a request from any customer and providing convenient suppliers with information about customer's prior evaluations;
accepting an offer from at least one said convenient supplier which includes supplier input information;
providing a weighted or non weighted evaluation of a supplier by a customer according to said supplier input information, and said importance index to provide a score according to said customers competition criteria;
determining the order of said offers according said score and said supplier input information;
accepting a selection by said customer of one said offer from at least one said convenient supplier to provide a selected supplier; and
informing each said selected supplier of said selection by said customer, wherein said at least one offer has supplier input information.

17. A method of awarding a supplier's offer based upon customer's competition criteria as in claim 16, accepting a decision by said customer about his final order of said offers;

18. A method of awarding a supplier's offer based upon customer's competition criteria as in claim 16, accepting mutual weighted or non weighted evaluation of customer's and supplier's performance of the task some time after the competition end.

19. A method of awarding a supplier's offer based upon customer's competition criteria as in claim 16, said method comprising the steps of:
searching for convenient suppliers based on said input of requirements from a customer;
informing said convenient suppliers of a request from said an evaluating customer;
accepting an offer from at least one supplier, wherein said at least one offer has supplier input information;
providing a weighted score by multiplying each said supplier input information by said importance index to provide a weighted score according to said customers competition criteria;
accepting a selection by a customer of at least one offer from at least one supplier according to said customers competition criteria; and
informing each said supplier of said selection by said an evaluating customer.

20. A method of awarding a supplier's offer based upon customer's competition criteria as in claim 16, further comprising the step of:
accepting a weighted or not weighted evaluation from a customer, wherein said weighted evaluation changes according to each said customers rating criteria and rates said at least one suppliers performance.

21. A method of awarding a supplier's offer based upon customer's competition criteria as in claim 16, further comprising the step of:
making said weighted evaluation public.

22. A method of awarding a supplier's offer based upon customer's competition criteria as in claim 16, wherein said requirements may be selected from the group consisting of project description, turnaround, category type, business type, budget, planning, location, skills required, experience required, task duration, task frequency, other requirements, experience, lowest price, highest price, desired system evaluation and previous supplier's performance evaluations, efficiency on the system including number of successfully completed competitions and success in responding to a customer and comments.

23. A method of awarding a supplier's offer based upon customer's competition criteria as in claim 16, further comprising the steps of accepting a criteria of evaluation, wherein said criteria of evaluation may be selected from the group consisting of budget respect, planning respect, professional approach, personal approach, reliability, flexibility, overall impression, length, location, budget, planning, rating rules, comments and evaluation method.

24. A method of awarding a supplier's offer based upon customer's competition criteria as in claim 16, further comprising the steps of providing a system based supplier evaluation according to the number of successfully completed competitions and success in responding to a customer.

25. A method of awarding supplier's offer based upon customer's competition criteria as in claim 16, further comprising the step of:
accepting an evaluation of customer's performance by his supplier.

26. A method of awarding a supplier's offer based upon customer's competition criteria as in claim 16, further comprising the step of:
accepting a changed competition rating and a correlated importance index and other criteria from a customer to provide a changed weight index during the selection time;
accepting a changed supplier input information for rating and other criteria any moment during the selection time;
providing a new weighted score by multiplying each said supplier input information by said weight index to provide a weighted score according to said customers competition criteria wherein there is any change in said weighted score.

27. A method of awarding a supplier's offer based upon customer's competition as in claim 16, further comprising the steps of said supplier either accepting or withdrawing said offer according to a supplier selection criteria and competition evolution including other suppliers' offers, including change in customer's requirements

28. A method of awarding a supplier's offer based upon customer's competition as in claim 16, wherein said supplier selection criteria is selected from the group consisting of category (business type), budget, location, skills required, experience required, task duration, task frequency, other requirements and customer's performance criteria like: budget, respect, planning respect, professional approach, personal approach, reliability, flexibility, overall impression and comments, prior other supplier evaluation, efficiency on the system including number of successfully completed competitions and success in responding to a supplier and comments.

29. A method of awarding a supplier's offer based upon customer's competition criteria as in claim 16, further comprising the step of:
ranking said offer's according to said criteria importance to provide a ranked list of offers, wherein said ranked list of offers can dynamically change after a change in said customer's requirements or said offer;
providing said ranked list of offers to said customer;
providing a system allowing a customer to determine his own order of offers in addition to said ranked list of offers, wherein the final order of supplier's offers may public or private according to customer.

30. A method of awarding a supplier's offer based upon customer's competition criteria as in claim 16, wherein said adjusted weighted evaluation from said second customer is a dummy weighted evaluation.

31. A method of awarding a supplier's offer based upon customer's competition criteria, said method comprising the steps of:
accepting an input of requirements from a customer;
accepting a criteria of rating supplier offers to provide an importance input;
searching for convenient suppliers based on said requirements from said customer;
informing said convenient suppliers of a request from said customer;
accepting an offer from at least one supplier, wherein said at least one offer has supplier input information;
providing a score to said customer according to said importance input and said supplier input information to provide a rating;
accepting a selection by said customer of at least one offer from at least one supplier according to said customers competition criteria and said rating;
informing each said supplier of said selection by said customer.

32. A method as in claim 31, further comprising the step of:
Accepting at least one change of any competition criteria, their weight and even requirements by a customer at any time during the competition and the selection period; and
accepting at least one change of any offer aspect by any supplier at any time during the competition period.

33. A method as in claim 31, further comprising the step of:
determining said offers' order by said customer and informing said suppliers about customer's decision if desired by said customer; and
accepting mutual evaluation of customer's and supplier's performance of the task some time after the competition end.

34. A method as in claim 31, wherein said step of accepting an input of requirements from a customer further comprises the step of:
assigning a public or private status to at least one input of requirements.

35. A method of awarding a supplier's offer based upon customer's competition criteria as in claim 31, further comprising the step of:
accepting an evaluation from said customer, wherein said weighted evaluation is parsed and changes according to each said customers importance input.

36. A method of awarding a supplier's offer based upon customer's competition criteria as in claim 31, further comprising the step of:
making said weighted evaluation public.

37. A method of awarding a supplier's offer based upon customer's competition criteria as in claim 31, further comprising the step of:
accepting an evaluation of customer's performance by his supplier.

38. A method of awarding a supplier's offer based upon customer's competition criteria as in claim 31, wherein said requirements may be selected from the group consisting of project description, turnaround, category type, business type, budget, planning, location, skills required, experience required, task duration, task frequency, other requirements experience, lowest price, highest price, system evaluations, desired system evaluation and previous supplier's performance evaluations, efficiency on the system, number of successfully completed competitions, success in responding to a customer and comments.

39. A method of awarding a supplier's offer based upon customer's competition as in claim 31, further comprising the steps of accepting a criteria of evaluation, wherein said criteria of evaluation may be selected from the group consisting of budget respect, planning respect, professional approach, personal approach, reliability, flexibility, overall impression, length, location, budget, planning, rating rules, comments and evaluation method.

40. A method of awarding a supplier's offer based upon customer's competition as in claim 31, further comprising the steps of said supplier either accepting or withdrawing said offer according to competition evolution, other suppliers' offers and change in customer's requirements.

41. A method of awarding a supplier's offer based upon customer's competition as in claim 31, wherein said supplier selection criteria is selected from the group consisting of category type, business type, budget, location, skills required, experience required, task duration, task frequency, other requirements and customer's performance criteria like: budget, respect, planning respect, professional approach, personal approach, reliability, flexibility, overall impression, prior other supplier evaluation, efficiency on the system, number of successfully completed competitions and success in responding to a supplier and comments.

42. A method of awarding a supplier's offer based upon customer's competition criteria as in claim 31, further comprising the steps of providing an automatically generated system evaluation of said supplier.

43. A method of awarding a supplier's offer based upon customer's competition criteria as in claim 31, further comprising the step of:
accepting a changed criteria of rating and a correlated weight index and other criteria from a customer to provide a changed weight index during said competition time and said selection time;
accepting a changed supplier input information for rating and other criteria any moment during the selection time;
providing a new weighted score by multiplying each said supplier input information by said weight index to provide a weighted score according to said customers competition criteria wherein there is any change in said weighted score.

44. A method of awarding a supplier's offer based upon customer's competition criteria as in claim 31, further comprising the step of:
providing a weighted score according to a prior customer's evaluations, wherein said prior customer's evaluation is parsed according to supplier input information.

45. A method of awarding a supplier's offer based upon customer's competition criteria as in claim 31, further comprising the step of:
ranking said offer's according to said criteria importance to provide a ranked list of offers;
providing said ranked list of offers to said customer.

46. A method of awarding a supplier's offer based upon customer's competition criteria as in claim 31, wherein said first customer's evaluation of supplier's performance is a dummy weighted evaluation.
